(19) United States
(12) Patent Application Publication
(10) Pub. No.: US 2005/0129160 A1
(43) Pub. Date: Jun. 16, 2005

(54) Apparatus and method for facilitating nuclear fusion

(76) Inventor: Robert Indech, Norcross, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/735,406

(22) Filed: Dec. 12, 2003

(51) Int. Cl. G21B 1/00

(52) U.S. Cl. 376/100

(57) ABSTRACT

An apparatus and method for facilitating nuclear fusion, wherein micro-scale, controlled hydrogen nuclear fusion is effectuated without the introduction of extreme temperatures and pressures, and wherein the utilization of a geometrically-enhanced reacting surface induces and/or facilities multiple room temperature fusion reactions thereon.

### TECHNICAL FIELD

The present invention relates generally to methods of energy production, and more specifically to an apparatus and method for facilitating nuclear fusion, wherein the present invention is particularly suitable for, although not strictly limited to, facilitating a method of producing controlled hydrogen nuclear fusion on a micro-scale (i.e., hydrogen microfusion), and subsequently harnessing the energy released therefrom.

### BACKGROUND OF THE INVENTION

Fusion power is widely recognized as offering a nearly limitless and inexhaustible future source of energy. Specifically, in view of ever-increasing energy demands, present exorbitant energy consumption, steady depletion of conventional fossil fuel energy sources, and the environmental impact of nuclear fission-based energy production, nuclear fusion energy appears to be the universal panacea to the current energy crisis. Although a recognizably advantageous energy source, attempts at extracting such nearly limitless amounts of energy from nuclear fusion reactions in a controlled manner, as opposed to “uncontrolled” thermonuclear explosions, has proven an arduous and seemingly unattainable task.

In the typical fusion reaction, a fusion fuel, often composed of mass-2 and mass-3 isotopic hydrogen gas (i.e., deuterium and/or tritium, respectively) must be heated to high temperatures in order to convert the gas into a plasma, or high energy gas, wherein electrically-charged electrons are separated from the positively charged nuclei (i.e., deuterium and/or tritium ions). However, due to the inherent repulsive forces between the positively charged nuclei, the plasma gas must thereafter be heated to extreme temperatures to overcome such repulsive forces and facilitate the fusion process. More specifically, because temperature is a measure of the translational kinetic energy of atoms and nuclei, heating the plasma gas to extreme temperatures results in an increase in kinetic energy of the ions, and thus, the subsequent high-speed collision between the ions sufficient to overcome the repulsive forces therebetween, and permit fusion of the nuclei. Fusion of the nuclei results in a release of energy. Such an occurrence or method is well demonstrated in the thermonuclear bomb.

Accordingly, the goal of controlled fusion research programs is to produce enough fusion reactions to achieve “ignition”, and thereby permit the process to become self-sustaining via the continual addition of fusion fuel, whereby heat energy released from the reaction may be conveniently extracted for subsequent conversion into electrical energy. Unfortunately, to obtain such a self-sustaining process, current methods result in more energy being consumed than is produced via the ensuing fusion reaction. Specifically, energy is consumed to heat the initial fusion fuel to plasma, and to subsequently bring the plasma to optimal fusion-inducing temperatures. Additionally, the amount of energy required to maintain the plasma at such a fusion-inducing temperature, and to confine a sufficient quantity of reacting nuclei for an adequate period of time to permit the release of energy, is significantly higher than the amount of energy produced from the fusion reactions. Moreover, a further problem encountered by researchers is the inability to appropriately and effectively harness the fusion energy released for subsequent conversion into electricity.

Furthermore, although current technology makes deuterium-tritium nuclear fusion feasible, yet still highly energy-consumptive in view of overall energy yield, it is believed that deuterium-deuterium nuclear fusion would effectively be more energy consumptive than a deuterium-tritium nuclear fusion reaction, as higher temperatures would be required to bring the deuterium ion plasma gas to fusion-inducing temperatures.

Although torus-shaped apparatuses having toroidal magnetic fields are currently utilized to confine plasma, and subsequently subject the plasma to extremely high temperatures and pressures for atomic nuclei fusion, such apparatuses are extremely expensive to construct, and still present the problem of requiring more energy to implement the fusion reaction than is released thereby.

In an attempt to reduce the amount of energy consumption utilized to implement conventional “heat-catalyzed” fusion reactions, many researchers are now experimenting with other fusion reaction techniques and processes. One such process involves muon-catalyzed fusion between hydrogen nuclei. Specifically, because the muon is much heavier than the electron (i.e., approximately 207 times the mass of an electron), its normal orbit is much closer to the nuclei, so the muonic atomic system is much smaller and more tightly bound than its electronic version. The muon effectively shields the repulsive electrical force between the two positively charged nuclei, allowing the nuclei to come together close enough to fuse. The goal of such muon-catalyzed fusion reactions is to induce the muon to catalyze enough reactions for a self-sustaining fusion process. Unfortunately however, often times the muon “sticks” to a charged fusion product, such as an alpha particle (i.e., helium nucleus), and is lost to the cycle. As such, because the muon particle must attempt to catalyze approximately 300 fusions in its average 2.2 microsecond lifetime for a self-sustaining reaction to occur, a muon particle sticking to a charged fusion product obviously results in cessation of the fusion process, and thus, the non-occurrence of a self-sustained or “ignited” fusion reaction. Furthermore, the conventional method of producing muon particles in a particle accelerator requires more energy for production than is derived from the subsequent hydrogen fusion reactions prior to loss of the muon particle.

Still others have attempted, with measurable and observable success, albeit controversial, the fusion of nuclei at room temperature. Coined “cold fusion”, the process involves the low-voltage electrolysis of heavy water, utilizing platinum, palladium or titanium electrodes onto which deuterium nuclei are said to concentrate at very high densities. Although certain results have shown the cold fusion reaction to yield excess or “latent” heat, attempts to duplicate or reproduce experimental results for producing a self-sustaining fusion reaction have not been successful. Unfortunately, only theories exist to explain the shortcomings of the cold fusion process, leaving researchers of different schools of thought (i.e., those utilizing extreme temperatures and pressures to catalyze fusion) to discount, albeit arguably prematurely, the potential and possibility of such cold fusion reactions and processes. Additionally, although it is recognized that the availability of an effective reacting surface and the ability to immediately remove reaction-generated energy is crucial in the success and potential reproducibility of cold fusion reactions, current reacting surfaces utilized in the cold fusion process quickly disintegrate, either as a result of structural deficiencies of the reacting surface utilized and/or the delayed capture of energy released from the reaction. Disintegration of the reacting surface often results in the formation of pits and/or craters therein, and thus, the cessation of the reaction process. Moreover, as no effective method is available for the rapid removal of energy from the reacting surface, disintegration of conventional cold fusion reacting surfaces is seemingly inevitable. Additionally, there is considerable controversy as to the exact method of surface preparation, thus leading to non-reproducibility of results.

Nonetheless, it is incontrovertible that fusion, in general, does occur, as is amply evidenced in the operation of the thermonuclear bomb.

Therefore, it is readily apparent that there is a need for an apparatus and method for facilitating nuclear fusion, wherein micro-scale, controlled hydrogen nuclear fusion is effectuated without the introduction of extreme temperatures and pressures, and wherein the utilization of a geometrically-enhanced reacting surface induces and/or facilities multiple near room temperature fusion reactions thereon and thereover, thus providing the requisite reaction “ignition” for a self-sustaining fusion reaction process. There is a further need for an apparatus and method for facilitating nuclear fusion that provides for the rapid collection of energy released from fusion reactions for subsequent conversion of same into useful energy sources.

### BRIEF SUMMARY OF THE INVENTION

Briefly described, in a preferred embodiment, the present invention overcomes the above-mentioned disadvantages and meets the recognized need for such a device by providing an apparatus and method for facilitating nuclear fusion, wherein micro-scale, controlled hydrogen nuclear fusion is promoted on and over a geometrically-enhanced reacting surface comprising a plurality of cone-shaped structures extending therefrom, and wherein the “multi-cone” reacting surface is manufactured from a suitable material having a particular affinity for deuterium ions to preload themselves thereon and between the lattice interstices thereof. The present invention contemplates that fusion between deuterium nuclei may be promoted on the reactive multi-cone surface not with the conventional application or introduction of extreme temperatures and pressures thereover, but instead through the effective cancellation or electron shielding of the positively-charged repulsive forces between two deuterium nuclei located near the tips of each cone structure (i.e., preloaded within the lattice interstices thereof). As such, an electron source supplies a sufficient quantity of free electrons to effectively shield the positively charged reacting deuterium nuclei, and thus permits fusion between same.

However, to produce and concentrate a net charge density sufficient to provide the requisite shielding to overcome the repulsive forces and permit nuclear fusion of the two nuclei at preferably room temperature, a potential is applied over the deuterium-preloaded reacting surface, wherein elementary electrostatics dictates the accumulation or concentration of free electrons proximal to the tip of each cone structure extending from the reacting surface. That is, the cone tips, in the presence of an applied potential, function as active lattice site electron concentrators that provide the requisite net charge density sufficient to shield the positively-charged repulsive forces of two deuterium nuclei positioned at the tip of a selected cone, thereby permitting the fusion between same.

As such, within the presence of an applied potential and free electrons, a plurality of such deuterium-preloaded cone-shaped structures advantageously facilities multiple room temperature fusion reactions, thus providing the requisite reaction “ignition” for a self-sustaining fusion reaction process.

It is further contemplated that the heat energy released from such multiple fusion reactions (i.e., chain-reactions) may be captured via an ultra-thin membrane on a heat exchanger, wherein the heat energy would be siphoned-off as heat energy and converted to conventional electrical energy sources.

Accordingly, a feature and advantage of the present invention is its ability to promote fusion reactions without conventional application of extreme heat and pressure.

Another feature and advantage of the present invention is its electron-catalyzed fusion reaction.

Still another feature and advantage of the present invention is its geometrically-enhanced reacting surface that comprises a plurality of cone-shaped or wedge-shaped structures that, within the presence of an applied potential and free electrons, function as active lattice site electron concentrators that provide the requisite net charge density sufficient to shield positively-charged repulsive forces of two deuterium nuclei positioned near the tip of a selected cone, thereby permitting the fusion between same.

Yet another feature and advantage of the present invention is its geometrically-enhanced reacting surface that comprises a plurality of cone-shaped or wedge-shaped structures that advantageously facilitate multiple room temperature fusion reactions.

Yet still another feature and advantage of the present invention is the application of elementary electrostatic principles and teachings that provide a reacting surface capable of promoting a net charge density sufficient to provide the requisite electron shielding necessary to permit nuclear fusion at room temperature, or other given temperature.

A further feature and advantage of the present invention is its ability to release more energy than is consumed or applied to promote the fusion reaction.

Still a further feature and advantage of the present invention is its ability to permit the capture of heat energy for conversion of same into electricity.

Yet still a further feature and advantage of the present invention is its ability to promote or ignite a self-sustain fusion reaction.

Still another and further feature and advantage of the present invention is its ability to resolve the above-described problems and deficiencies associated with muonic-catalyzed fusion reactions via the application of elementary electrostatic principles, electron screening principles, and a deuterium-preloaded charged lattice structure (i.e., charged multi-cone reacting surface).

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of a reacting surface according to a preferred embodiment of the present invention;

FIG. 2 is an illustration detailing the geometry of a reacting surface according to a preferred embodiment of the present invention; and,

FIG. 3 is a perspective view of a reacting surface according to an alternate embodiment of the present invention.

### DETAILED DESCRIPTION OF THE PREFERRED AND SELECTED ALTERNATIVE EMBODIMENTS

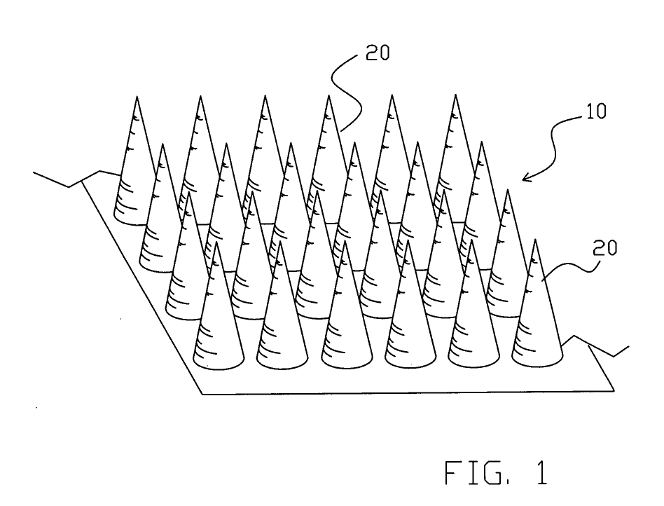

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

As addressed above, a muon particle is characterized by a negative charge equal to the electron, but is approximately 207 times the mass of an electron. As such, the normal orbit of a muon is much closer to the nuclei than an electron. Therefore, scientists have determined that substitution of the electron in a deuterium atom with a muon particle will allow nuclear fusion to occur at room temperature. That is, the muon effectively shields the repulsive electrical force between the two positively charged nuclei, allowing the nuclei to come together close enough to fuse.

More specifically, quantum mechanics predicts, and experiments confirm, that the ionization of the ground level electron in the hydrogen atom is −13.6 electron volts (eV). For the muonic deuterium atom, the muon ionization value is 200×−13.6=−2720 eV. The mean radius for the electron in the hydrogen atom, termed the Bohr radius, is 5.3×10⁻¹¹ meters, and for the muonic deuterium atom is 5.3×10⁻¹¹/200=2.6×10⁻¹³ meters. As such, the lower radius of the muon increases the electronic screening, and thus radically lowers the critical temperature required for fusion by approximately a factor of 10⁵.

Unfortunately however, often times the muon “sticks” to a charged fusion product, such as an alpha particle (i.e., helium nucleus), and is lost to the cycle. As such, because the muon particle must attempt to catalyze approximately 300 fusions in its average 2.2 microsecond lifetime for a self-sustaining reaction to occur, a muon particle sticking to a charged fusion product obviously results in cessation of the fusion process, and thus, the non-occurrence of a self-sustained or “ignited” fusion reaction. The energy conventionally required to produce the muon particle exceeds the energy gained from the hydrogen fusion reactions it catalyzes.

Accordingly, instead of utilizing muon-dependent or muon-catalytic processes to induce fusion reactions, the present invention preferably contemplates utilizing electron screening to promote nuclear fusion between deuterium nuclei at room temperature. As more fully described below, the present invention effectively defines formulae for determining the effect of electron screening on reacting nuclei, and thus solves for the muonic equivalent of electron shielding with only electrons present before the reacting nuclei, thus permitting nuclear fusion of same at room temperature.

It is known that for an atom with a low atomic number, as the atomic number increases, the ionization energy for the innermost electron increases as the square of this number. To remove all electrons from the atom, the ionization energy for the entire atom must also include corrections for electron-electron interaction. For the isolated atom, any electrons greater than two will assume higher energy outer orbitals than the two innermost electrons in the “s” orbitals. Such higher energy outer orbitals are conventionally referred to as “p”, “d”, and “f”, wherein electrons residing therein require substantially less energy to ionize than the electrons within the “s” orbital.

For the isolated deuterium atom, although charged, the effect of electron screening on the approaching second deuterium ion will be minimal, wherein the distance of the second deuterium ion to the primary deuterium nucleus is within the innermost electron orbital. However, because an electron is not a rigid particle, the Heisenberg uncertainty principle must be considered, and thus the exact position of the electron may at some time be quite close to the nucleus, allowing sufficient screening to reduce the critical temperature for fusion. Clearly, the probability of close nuclear screening increases as the number of electrons circulating about the atom increases. Quantum tunneling must also be accounted for, as when the second deuterium nucleus effectively “tunnels” through the critical energy barrier to fuse with the first deuterium nucleus. Again, the probability of occurrence of the tunneling effect increases with increasing electron density around the atom.

However, for lattice charges that do not attach to the deuterium ion, but rather attach to the lattice atoms, electrons may have a substantial probability of being close to the deuterium nucleus. To determine the relationship between electron mass, m, valence, Z, and ionization energy, Eₙ, the following equation (1) is preferably utilized:
Eₙ=m*Z^{w}*Eₙₒ
wherein Eₙ is the univalent ionization energy, and wherein w is an undetermined coefficient. For the isolated deuterium atom, w may be equal to 0.5, while for the model of screening due to lattice charges, w may be equal to 3. It is suggested that an intermediate situation results when w is equal to 2. For the munoic deuterium atom, the ionization energy increases by a factor of approximately 200 due to the inherent muonic mass, but one may solve for the muonic equivalent of electronic shielding, Z_{equiv} with only electrons present, wherein the following equation (2) is preferably utilized:
Eₙₒ*mₘᵤₒₙ*1²=Eₙₒ*m_{electron}*Z²_{equiv}

Solving for Z_{equiv} yields a value of 14.4 electron equivalents to shield to muonic level to allow room temperature fusion. The concept of an isolated single proton atom with 14 circulating electrons grossly violates electric neutrality principle and is not found isolated in nature.

For practical purposes, the final magnitude of the strong nuclear force does not depend on the type of nucleon involved, nor the proton or neutron, but rather the number of independent nucleon-nucleon interactions present. For a hydrogen-hydrogen combination, there is one strong nuclear attractive force acting; for a deuterium-deuterium combination, there are four; and for a tritium-tritium combination, there are nine. Whether one considers the simple nuclear model or the overlapping nucleon quantum mechanical wave, the maximum of the strong nuclear forces require a net minimization of the nucleon separation distance for all nucleons, mediated by the form of the nuclear attraction force.

In determining an equivalence method for hydrogen fusion, a simple mathematical model of the hydrogen fusion temperature, the number of strong nucleon interactions and the number of equivalent electrons is preferably constructed as follows:
log(T)=a₀*nₑ+a₁*nₙ+a₂ Equation (3)
wherein T is temperature, nₑ is the number of equivalent electrons, nₙ is the number of strong nucleon interactions, and a₀, a₁, and a₂ are undetermined constants. However, the a₀, a₁, and a₂ constants may be solved mathematically from placement of experimentally determined data in the following matrix formulation (4):

$$log ( \begin{matrix}3 * {10}^{2} \\ 3 * {10}^{6} \\ 3 * {10}^{7} \\ 3 * {10}^{8}\end{matrix} ) = {a}_{0} * ( \begin{matrix}14.4 \\ 0 \\ 0 \\ 0\end{matrix} ) + {a}_{1} * ( \begin{matrix}4 \\ 9 \\ 4 \\ 1\end{matrix} ) + {a}_{2} * ( \begin{matrix}1 \\ 1 \\ 1 \\ 1\end{matrix} )$$

Solving the above matrix equation (4) yields a least squares solution of a₀=−0.8256, a₁=−0.5639, a₂=19.85.

The above formula is preferably utilized to calculate the required temperature for fusion with a given neutral atom type (hydrogen, deuterium or tritium), or to calculate the excess local charge density required at a specific temperature and ion type. Implicit within this model is the assumption of equivalence of fusion probability with equivalence of total electron ionization value.

For example, for 1000° Kelvin deuterium-deuterium (D-D) fusion, the increase of electron local charge density, nₑᵢ, over the two deuterium atoms normal charge density is given by solving equation (3) with nₑᵢ=nₑ−2, T=1000, nₙ=4, thus yielding nₑᵢ=10.94, or 11 extra equivalent electron charges per molecule for deuterium-deuterium fusion to occur at near room temperature.

In order for deuterium-deuterium fusion to occur via the above-referenced electron shielding technique, an appropriate, highly charged reacting surface must be made available. As such, the present invention preferably provides a geometrically-enhanced surface to assist in the production of a net charge density sufficient to shield the positively-charged repulsive forces of two deuterium nuclei; thus, permitting the room temperature fusion between same.

More specifically, and with pertinent reference to FIG. 1, the present invention in its preferred form contemplates the construction of a reacting surface 10 preferably having a plurality of spaced-apart cones 20 extending therefrom, and integrally formed therewith. Such a “multi-cone” reacting surface 10 preferably functions to facilitate the production of a sufficient net charge density required for effective shielding to permit nuclear fusion at a given temperature (i.e., preferably room temperature). The following presentation of electrostatic principles is provided to facilitate an understanding of the geometric contribution of reacting surface 10 and cones 20 in the fusion process.

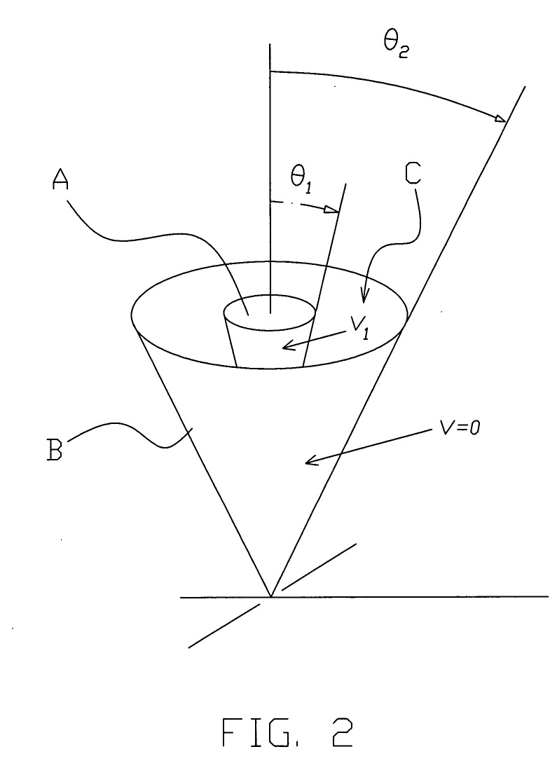

With specific reference now to FIG. 2, depicted therein is an illustrative representative of the geometry and charge density development of the present reacting surface 10 and associated cones 20. Two surfaces are illustrated, inner cone A and outer cone B, preferably disposed in a cone-within-a-cone relationship. Preferably, outer cone B may be considered a flat plate by setting the angle θ₂ to π/2 degrees.

Consider now that the surfaces of cones A and B are extremely close at the vertexes thereof, but are preferably not touching. Cone A is preferably defined by angle θ₁, wherein the position along the surface of cone A is preferably defined by a variable r, measured from the mathematical point of surface intersection. Additionally, cone B, or the flat plate, is preferably set as potential φ=0, wherein cone A is preferably set as potential φ=V₁=V₀.

Preferably, no free charges exist within space C between cone A and cone B (flat plate); thus, the distribution of potential within space C is governed by Laplaces' equation: ∇²φ=0.

Working in cylindrical coordinates, and taking advantage of the radial symmetry of the problem, preferably permits the solution of Laplaces' equation in terms of the arbitrary test angle θ, wherein the solution is preferably given in the following equation (5), valid in the region π/2≦θ≦θ₁

$$Equation ( 5 ) : ϕ = {V}_{0} * ( \frac{ln ( tan ( θ / 2 ) ) - ln ( tan ( π / 4 ) )}{ln ( tan ( {θ}_{1} / 2 ) ) - ln ( tan ( π / 4 ) )} )$$

Clearly, equation (5) satisfies the constraints. The vector electric field, \overline{E}, is determined in these cylindrical coordinates by equation (6) below. The vector displacement field, \overline{D}, is determined in the vacuum by equation (7) below. On the conductor surface, the scalar charge density, ρₛ, is equal to the normal component of the displacement field, as given in equation (8) below.
\overline{E}=−1/r*dφ/dθ Equation (6)
\overline{D}=ε₀*E Equation (7)
ρₛ=D_{N} Equation (8)
Solving the above model for the charge density yields equation (9):

$${ρ}_{s} = ( \frac{- {ɛ}_{0} * {V}_{o}}{r * sin ( {θ}_{1} )} ) * ( \frac{1}{ln ( tan ( {θ}_{1} / 2 ) ) - ln ( tan ( π / 4 ) )} )$$

It is recognized, as a peculiarity of the geometry of cones 20, that the charge density may become infinite at the tips thereof. Setting a potential Vₒ, and a given geometry θ₁, cone 20 may reach any charge density a certain critical distance from the tip thereof, and will exceed this charge density from such a critical distance to the tip. In practical construction, the tip of cone 20 will be a single atom and not infinitely sharp, and thus charge density will be finite. Further, the dielectric constant will be increased due to the presence of the gas in the previously defined vacuum.

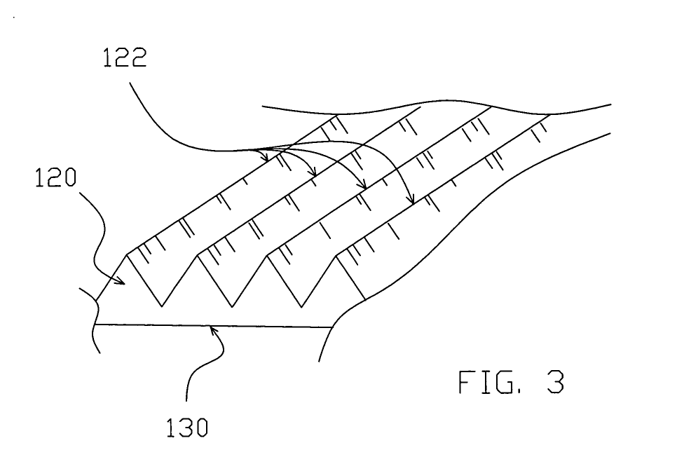

With reference to FIG. 3, the geometry leading to a (1/r) charge relationship may also be considered as a two-dimensional equivalent of cone 20 (i.e., the sharp triangle), extended into three dimensions as a sharp wedge 120. Thus, a reacting surface may alternatively be constructed as a plurality of sharp wedges 120 on a planar base 130, wherein each wedge 120 could possess active lattice site electron concentration areas 122 to equally effectively facilitate the present cold fusion method described herein.

To illustrate application of the above formulae, and in consideration of surface 10 and associated cones 20, if one considers a 2 angstrom spacing between adjacent conductive surface atoms in cone 20, then 12.2 electrons as excess charge density per atomic spacing would yield a required surface charge density of ρₛ as 19 coulombs/square meter of surface. For a cone angle θ₁ of 5 degrees, and a 5000 volt applied potential, the critical distance from the tip of cone 20 would be 8.5×10⁻⁹ meters, and the total tip surface area available to promote fusion would be 2×10⁻¹⁷ square meters, thus representing 495 atomic lattice sites per cone 20.

It should be recognized that although FIG. 1 illustrates a plurality of cones 20, and FIG. 3 a plurality of wedges 120, for efficient operation of the present invention, only one cone 20 or wedge 120 is required for the fusion reaction to occur. Additionally, it should be noted that the mathematical derivation for the concentration of charge is idealized and assumes no physical distance between the peaked surface (i.e., tip of cone 20) and the reference ground plane. In reality, however, a separation distance will exist, albeit finite, and thus lead to a charge density solution that does not quite vary as (1/r). However, minimization of this separation distance, coincident with maintaining an ionized gas in the interval, but not allowing arc-over between the peaked surface and the reference ground plane, will still give and approximate (1/r) character.

The present invention contemplates that fusion will preferably only occur on the surface layer of atoms constructing cone 20, and further that the material selected to construct cones 20, and/or surface 10 in general, would preferably possess an affinity for deuterium to preload itself within the lattice interstices of each surface lattice site before a potential is applied thereacross. Such materials may include, for exemplary purposes only and without limitation, platinum, palladium and/or titanium, each of which are excellent hydrogen (proton) acceptor surfaces, thereby allowing substantial loading of the deuterium gas within the metallic matrices/interstices thereof. Additionally, utilization of surface 10 and associated cones 20 as active lattice site electron concentrators preferably requires that the deuterium first be ionized, so as to permit interaction (i.e., preloading) of same with cones 20. Thereafter, the tips of cones 20, in the presence of an applied potential and free electrons (i.e., from a suitable electron source), function as active lattice site electron concentrators that provide the requisite net charge density sufficient to shield the positively-charged repulsive forces of two deuterium nuclei positioned at the tip of a selected cone 20, thereby permitting the fusion between same, as more fully described below. It should be recognized that a plurality of such deuterium-preloaded cones 20 would advantageously facilitate multiple room temperature fusion reactions, thus providing the requisite reaction “ignition” for a self-sustaining fusion reaction process.

Referring back to FIG. 1, the complete reacting surface 10 would preferably be constructed as a regular number of spaced cones 20, wherein the reacting surface of each cone 20 preferably ends in a point, or practically, in a small number of atoms at the tip of each cone 20. The underlying base of surface 10 may be macroscopically curved with little effect on the charge concentrator effect.

Additionally, reacting surface 10 and associated cones 20 must preferably be manufactured from a conductive material. As such, although metallic compositions are not necessarily required for construction of reacting surface 10 and cones 20, the atomic binding of the selected material must be sufficient to maintain its own internal structure in the presence of extremely high excess charge accumulation.

It is further preferred that the number of such cones 20 or peaks be proportional to the number of reactive sites for the fusion to occur, and in proper design, would preferably be maximized per square base area over surface 10. As such, one may consider that each cone 20 comprises a preferred minimum height to base width ratio of 10 to 1. For example, for a 10 to 1 ratio for total cone 20 height to critical distance, and dense packing of cones 20 over a planar surface, one could place 1.2×10¹³ peaks on a simple 3 cm by 3 cm flat or planar surface. Current nanotechnology processing techniques could effectively permit construction of such a surface 10.

In the foregoing example, a single burst of energy output for 6×10¹⁵ reactions (i.e., 495 atomic lattice points multiplied by 1.2×10¹³ peaks on a 3 cm by 3 cm planar surface) for deuterium fusion is 144 kilojoules, utilizing a mass of 4×10⁻⁸ grams of deuterium. The burst rate is preferably controlled by electronics in the control circuit, the deuterium replenishment rate, and the availability of the reacting surface.

If a higher value of electron equivalents is required, then less sites per peak are available for fusion. Surface 10 would then be less efficient in the number of fusion reactions per unit area, but reactions would still occur. Thus, an error in the calculation of the “w” exponent in Equation (1) above would still allow the technique to work.

It should be recognized that cones 20, and surface 10 in general, utilized for producing high local charge density to facilitate room temperature fusion, are not limited to hydrogen fusion alone. Such a charge density could be utilized to create local conditions for fundamental particle generation by injection of higher order atomic nuclei onto surface 10, thereby allowing nuclear combination, and capturing the secondary particles generated thereby. With very rapid heat capture, surface 10 and associated cones 20 could be constructed as an ultra-thin membrane on a heat exchanger, wherein most of the fusion energy could be siphoned-off as heat and subsequently converted to electricity.

Moreover, with the present reaction surface 10 in general, injection of a mix of higher number atomic nuclei (such as carbon, etc.) after the system has been deuterium loaded would effectively permit nuclear transmutation. Such an alternate application could be very energy efficient, as the voltage fields are electrostatic in nature, and thus, consume little power except that utilized by the nuclear combination.

Although deuterium is the preferred primary fuel utilized to implement the present method of fusion, it should be recognized that the present method, and reacting surface 10 in general, could be utilized to fuse nuclei of atomic elements having higher atomic numbers than isotopic hydrogen.

Additionally, although near room temperature is contemplated to effectuate the present fusion method via utilization of the preferred and/or alternate embodiments of reacting surface 10, it should be recognized that a multitude of suitable temperatures could alternatively be utilized in conjunction with the various embodiment of reacting surface 10 to facilitate nuclear fusion between isotopic hydrogen and/or other suitable atomic elements having higher atomic numbers.

It should be recognized that the critical distance calculated for the tip of cone 20 is an average, and that the utilization of deuterium atoms with kinetic energies in excess of the average temperature-dependent kinetic energy, will increase this effective critical distance, thereby considerably adding to the number of active reaction sites.

It should further be recognized that the influence of electron shielding is not limited to deuterium-deuterium fusion reactions alone. That is, because the ignition temperature of a tritium-tritium reaction is over a factor of ten less than the ignition temperature of a deuterium-deuterium reaction, many more sites would be active for a tritium-tritium reaction on a surface 10 having the same geometry and charge density as a surface 10 utilized to promote a deuterium-deuterium reaction. However, due to ready availability of deuterium (i.e., occurring naturally in approximately 1 part in 6000 parts of ordinary water), and in view of the difficulty and tight regulation involved in the manufacture of tritium gas (i.e., a highly poisonous gas), deuterium is the preferred reaction fuel. It is further contemplated that a deuterium and tritium gas mix could be utilized as the reaction fuel in implementing the present fusion method, wherein the gas mix could preload on surface 10 and associated cones 20 (or wedges 120) prior to applying a potential across same.

It should still further be recognized that the geometry of surface 10 does not necessarily have to comprise the rigid cone-shape of cone 20, nor does planar base 130 necessarily have to comprise the rigid wedge-shaped of wedge 120. That is, surface 10 could be sharply pointed, comprise any selected number of protrusions, wherein each such protrusion would comprise an apex, or, alternatively, could be in the form of a sharply pointed structure or protrusion in general. Cones 20 and wedges 120 are, respectively, 3-dimensional and 2-dimensional idealizations of the sharply-pointed geometric characteristic that surface 10 should preferably embody to facilitate the present fusion method. Accordingly, the charge density derived from the solution of Laplace's equation of electrostatics does not necessarily have to comprise an exact (1/r) character, just a dominant (1/r) character that can be attained in a sharply-pointed geometry of surface 10. Fabrication of such a surface 10 comprising a sharply-pointed geometry or micro-peaks in general, could be facilitated via semi-random growth of metal dendrites on surface 10 via a conventional electroplating apparatus. As such, neither the regularity of such micro-peaks, nor the spacing of same, would be critical to a fusion reaction. However, competent engineering practice would attempt to maximize the number of active peaks or sites per unit surface area. Alternatively, fabrication of such micro-peaks, or cones 20 and/or wedges 120, could be facilitated via suitable nanotechnology processes and apparatuses.

It should also be recognized that not only is the sharply-pointed characteristics or shape of reacting surface 10 important, but also that there exist an electrically neutral plane in very close proximity to reacting surface 10, but not touching same, with hydrogen gas (or isotopes thereof) between reacting surface 10 and the electrically neutral plane, and that there be sufficient electrical potential difference between reacting surface 10 and the electrically neutral plane so as to achieve the necessary reacting conditions set forth herein.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. An apparatus for promoting a nuclear fusion reaction between ions, said apparatus comprising:
a reacting surface comprising at least one protrusion extending therefrom, wherein said protrusion comprises at least one apex.

2. The apparatus of claim 1, wherein said reacting surface and said at least one protrusion are constructed from a material comprising an affinity for the ions to preload within lattice interstices thereof.

3. The apparatus of claim 2, wherein said at least one apex of said at least one protrusion functions as an active lattice site electron concentrator within the presence of electrons and a potential applied across said reacting surface, wherein the electrons are supplied via an electron source.

4. The apparatus of claim 3, wherein the applied potential across said reacting surface and said at least one protrusion results in the concentration or accumulation of the electrons proximal to said at least one apex of said at least one protrusion.

5. The apparatus of claim 4, wherein accumulation of the electrons proximal to said at least one apex of said at least one protrusion provides the requisite net charge density sufficient to shield the positively-charged repulsive forces of at least two of the ions positioned proximal to said at least one apex of said at least one protrusion, thereby permitting fusion between same.

6. The apparatus of claim 5, wherein nuclear fusion between at least two of the ions provides the requisite reaction ignition for promoting and producing subsequent nuclear fusion reactions between additional ions, and thus promotes a self-sustaining nuclear fusion reaction.

7. The apparatus of claim 4, wherein accumulation of the electrons proximal to said at least one apex of said at least one protrusion provides the requisite net charge density sufficient to shield the positively-charged repulsive forces of at least two of the ions positioned at said at least one apex of said at least one protrusion, thereby permitting fusion between same.

8. The apparatus of claim 7, wherein nuclear fusion between at least two of the ions provides the requisite reaction ignition for promoting and producing subsequent nuclear fusion reactions between additional ions, and thus promotes a self-sustaining nuclear fusion reaction.

9. The apparatus of claim 1, wherein said reacting surface comprises a plurality of protrusions extending therefrom, wherein each protrusion of said plurality of protrusions comprises at least one apex.

10. The apparatus of claim 1, wherein the ions are deuterium ions.

11. The apparatus of claim 1, wherein the ions are tritium ions.

12. The apparatus of claim 1, wherein the ions are deuterium ions and tritium ions.

13. The apparatus of claim 1, wherein the ions are ions of atomic elements having higher atomic numbers than isotopic hydrogen.

14. The apparatus of claim 1, wherein said reacting surface and associated said at least one protrusion are constructed as an ultra-thin membrane on a heat exchanger, wherein fusion energy release by the nuclear reaction is siphoned-off as heat through said reacting surface and into said heat exchanger for subsequent conversion into electricity.

15. An apparatus for promoting a nuclear fusion reaction between ions, said apparatus comprising:
a reacting surface comprising at least one cone extending therefrom.

16. The apparatus of claim 15, wherein said reacting surface and said at least one cone are constructed from a material comprising an affinity for the ions to preload within lattice interstices thereof.

17. The apparatus of claim 16, wherein a tip of said at least one cone functions as an active lattice site electron concentrator within the presence of electrons and a potential applied across said reacting surface, wherein the electrons are supplied via an electron source.

18. The apparatus of claim 17, wherein the applied potential across said reacting surface and said at least one cone results in the concentration or accumulation of the electrons proximal to said tip of said at least one cone.

19. The apparatus of claim 18, wherein accumulation of the electrons proximal to said tip of said at least one cone provides the requisite net charge density sufficient to shield the positively-charged repulsive forces of at least two of the ions positioned proximal to said tip of said at least one cone, thereby permitting fusion between same.

20. The apparatus of claim 19, wherein nuclear fusion between at least two of the ions provides the requisite reaction ignition for promoting and producing subsequent nuclear fusion reactions between additional ions, and thus promotes a self-sustaining nuclear fusion reaction.

21. The apparatus of claim 18, wherein accumulation of the electrons proximal to said tip of said at least one cone provides the requisite net charge density sufficient to shield the positively-charged repulsive forces of at least two of the ions positioned at said tip of said at least one cone, thereby permitting fusion between same.

22. The apparatus of claim 21, wherein nuclear fusion between at least two of the ions provides the requisite reaction ignition for promoting and producing subsequent nuclear fusion reactions between additional ions, and thus promotes a self-sustaining nuclear fusion reaction.

23. The apparatus of claim 15, wherein said reacting surface comprises a plurality of cones extending therefrom.

24. The apparatus of claim 15, wherein the ions are deuterium ions.

25. The apparatus of claim 15, wherein the ions are tritium ions.

26. The apparatus of claim 15, wherein the ions are deuterium ions and tritium ions.

27. The apparatus of claim 15, wherein the ions are ions of atomic elements having higher atomic numbers than isotopic hydrogen.

28. The apparatus of claim 15, wherein said reacting surface and associated said at least one cone are constructed as an ultra-thin membrane on a heat exchanger, wherein fusion energy release by the nuclear reaction is siphoned-off as heat through said reacting surface and into said heat exchanger for subsequent conversion into electricity.

29. An apparatus for promoting a nuclear fusion reaction between ions, said apparatus comprising:
a reacting surface comprising at least one wedge extending therefrom.

30. The apparatus of claim 29, wherein said reacting surface and said at least one wedge are constructed from a material comprising an affinity for the ions to preload within lattice interstices thereof.

31. The apparatus of claim 30, wherein an apex of said at least one wedge functions as an active lattice site electron concentrator within the presence of electrons and a potential applied across said reacting surface, wherein the electrons are supplied via an electron source.

32. The apparatus of claim 31, wherein the applied potential across said reacting surface and said at least one wedge results in the concentration or accumulation of the electrons proximal to said apex of said at least one wedge.

33. The apparatus of claim 32, wherein accumulation of the electrons proximal to said apex of said at least one wedge provides the requisite net charge density sufficient to shield the positively-charged repulsive forces of at least two of the ions positioned proximal to said apex of said at least one wedge, thereby permitting fusion between same.

34. The apparatus of claim 33, wherein nuclear fusion between at least two of the ions provides the requisite reaction ignition for promoting and producing subsequent nuclear fusion reactions between additional ions, and thus promotes a self-sustaining nuclear fusion reaction.

35. The apparatus of claim 32, wherein accumulation of the electrons proximal to said apex of said at least one wedge provides the requisite net charge density sufficient to shield the positively-charged repulsive forces of at least two of the ions positioned at said apex of said at least one wedge, thereby permitting fusion between same.

36. The apparatus of claim 35, wherein nuclear fusion between at least two of the ions provides the requisite reaction ignition for promoting and producing subsequent nuclear fusion reactions between additional ions, and thus promotes a self-sustaining nuclear fusion reaction.

37. The apparatus of claim 29, wherein said reacting surface comprises a plurality of wedges extending therefrom.

38. The apparatus of claim 29, wherein the ions are deuterium ions.

39. The apparatus of claim 29, wherein the ions are tritium ions.

40. The apparatus of claim 29, wherein the ions are deuterium ions and tritium ions.

41. The apparatus of claim 29, wherein the ions are ions of atomic elements having higher atomic numbers than isotopic hydrogen.

42. The apparatus of claim 29, wherein said reacting surface and associated said at least one wedge are constructed as an ultra-thin membrane on a heat exchanger, wherein fusion energy release by the nuclear reaction is siphoned-off as heat through said reacting surface and into said heat exchanger for subsequent conversion into electricity.

43. A method of promoting a nuclear fusion reaction between ions, said method comprising the step of:
a. obtaining a reacting surface comprising at least one protrusion extending therefrom, wherein said protrusion comprises at least one apex.

44. The method of claim 43, further comprising the step of preloading the ions within lattice interstices of said reacting surface and associated said at least one protrusion.

45. The method of claim 44, further comprising the step of applying a potential across said reacting surface and associated said at least one protrusion within the presence of electrons, wherein the electrons are supplied via an electron source.

46. The method of claim 45, wherein said step of applying a potential across said reacting surface and said at least one protrusion results in the concentration or accumulation of the electrons proximal to said at least one apex of said at least one protrusion.

47. The method of claim 46, further comprising the step of permitting the electrons accumulated proximal to said at least one apex of said at least one protrusion to provide the requisite net charge density sufficient to shield the positively-charged repulsive forces of at least two of the ions positioned proximal to said at least one apex of said at least one protrusion, thereby permitting fusion between same.

48. The method of claim 47, further comprising the step of permitting nuclear fusion between at least two of the ions to provide the requisite reaction ignition for promoting and producing subsequent nuclear fusion reactions between additional ions, and thus promote a self-sustaining nuclear fusion reaction.

49. The method of claim 46, further comprising the step of permitting the electrons accumulated proximal to said at least one apex of said at least one protrusion to provide the requisite net charge density sufficient to shield the positively-charged repulsive forces of at least two of the ions positioned at said at least one apex of said at least one protrusion, thereby permitting fusion between same.

50. The method of claim 49, further comprising the step of permitting nuclear fusion between at least two of the ions to provide the requisite reaction ignition for promoting and producing subsequent nuclear fusion reactions between additional ions, and thus promote a self-sustaining nuclear fusion reaction.

51. The method of claim 43, wherein said reacting surface comprises a plurality of protrusions extending therefrom, wherein each protrusion of said plurality of protrusions comprises at least one apex.

52. The method of claim 43, wherein the ions are deuterium ions.

53. The method of claim 43, wherein the ions are tritium ions.

54. The method of claim 43, wherein the ions are deuterium ions and tritium ions.

55. The method of claim 43, wherein the ions are ions of atomic elements having higher atomic numbers than isotopic hydrogen.

56. The method of claim 43, wherein said reacting surface and associated said at least one protrusion are constructed as an ultra-thin membrane on a heat exchanger.

57. The method of claim 56, further comprising the step of capturing fusion energy released by the nuclear fusion reaction via siphoning-off the fusion energy as heat through said reacting surface and into said heat exchanger for subsequent conversion of the heat into electricity.

58. A method of promoting a nuclear fusion reaction between ions, said method comprising the step of:
a. obtaining a reacting surface comprising at least one cone.

59. The method of claim 58, further comprising the step of preloading the ions within lattice interstices of said reacting surface and associated said at least one cone.

60. The method of claim 59, further comprising the step of applying a potential across said reacting surface and associated said at least one cone within the presence of electrons, wherein the electrons are supplied via an electron source.

61. The method of claim 60, wherein said step of applying a potential across said reacting surface and said at least one cone results in the concentration or accumulation of the electrons proximal to a tip of said at least one cone.

62. The method of claim 61, further comprising the step of permitting the electrons accumulated proximal to said tip of said at least one cone to provide the requisite net charge density sufficient to shield the positively-charged repulsive forces of at least two of the ions positioned proximal to said tip of said at least one cone, thereby permitting fusion between same.

63. The method of claim 62, further comprising the step of permitting nuclear fusion between at least two of the ions to provide the requisite reaction ignition for promoting and producing subsequent nuclear fusion reactions between additional ions, and thus promote a self-sustaining nuclear fusion reaction.

64. The method of claim 61, further comprising the step of permitting the electrons accumulated proximal to said tip of said at least one cone to provide the requisite net charge density sufficient to shield the positively-charged repulsive forces of at least two of the ions positioned at said tip of said at least one cone, thereby permitting fusion between same.

65. The method of claim 64, further comprising the step of permitting nuclear fusion between at least two of the ions to provide the requisite reaction ignition for promoting and producing subsequent nuclear fusion reactions between additional ions, and thus promote a self-sustaining nuclear fusion reaction.

66. The method of claim 58, wherein said reacting surface comprises a plurality of cones.

67. The method of claim 58, wherein the ions are deuterium ions.

68. The method of claim 58, wherein the ions are tritium ions.

69. The method of claim 58, wherein the ions are deuterium ions and tritium ions.

70. The method of claim 58, wherein the ions are ions of atomic elements having higher atomic numbers than isotopic hydrogen.

71. The method of claim 58, wherein said reacting surface and associated said at least one cone are constructed as an ultra-thin membrane on a heat exchanger.

72. The method of claim 71, further comprising the step of capturing fusion energy released by the nuclear fusion reaction via siphoning-off the fusion energy as heat through said reacting surface and into said heat exchanger for subsequent conversion of the heat into electricity.

73. A method of promoting a nuclear fusion reaction between ions, said method comprising the step of:
a. obtaining a reacting surface comprising at least one wedge.

74. The method of claim 73, further comprising the step of preloading the ions within lattice interstices of said reacting surface and associated said at least one wedge.

75. The method of claim 74, further comprising the step of applying a potential across said reacting surface and associated said at least one wedge within the presence of electrons, wherein the electrons are supplied via an electron source.

76. The method of claim 75, wherein said step of applying a potential across said reacting surface and said at least one wedge results in the concentration or accumulation of the electrons proximal to an apex of said at least one wedge.

77. The method of claim 76, further comprising the step of permitting the electrons accumulated proximal to said apex of said at least one wedge to provide the requisite net charge density sufficient to shield the positively-charged repulsive forces of at least two of the ions positioned proximal to said apex of said at least one wedge, thereby permitting fusion between same.

78. The method of claim 77, further comprising the step of permitting nuclear fusion between at least two of the ions to provide the requisite reaction ignition for promoting and producing subsequent nuclear fusion reactions between additional ions, and thus promote a self-sustaining nuclear fusion reaction.

79. The method of claim 76, further comprising the step of permitting the electrons accumulated proximal to said apex of said at least one wedge to provide the requisite net charge density sufficient to shield the positively-charged repulsive forces of at least two of the ions positioned at said apex of said at least one wedge, thereby permitting fusion between same.

80. The method of claim 79, further comprising the step of permitting nuclear fusion between at least two of the ions to provide the requisite reaction ignition for promoting and producing subsequent nuclear fusion reactions between additional ions, and thus promote a self-sustaining nuclear fusion reaction.

81. The method of claim 73, wherein said reacting surface comprises a plurality of wedge.

82. The method of claim 73, wherein the ions are deuterium ions.

83. The method of claim 73, wherein the ions are tritium ions.

84. The method of claim 73, wherein the ions are deuterium ions and tritium ions.

85. The method of claim 73, wherein the ions are ions of atomic elements having higher atomic numbers than isotopic hydrogen.

86. The method of claim 73, wherein said reacting surface and associated said at least one wedge are constructed as an ultra-thin membrane on a heat exchanger.

87. The method of claim 86, further comprising the step of capturing fusion energy released by the nuclear fusion reaction via siphoning-off the fusion energy as heat through said reacting surface and into said heat exchanger for subsequent conversion of the heat into electricity.

88. A method of promoting a nuclear fusion reaction, said method comprising the step of:
a. utilizing electrons to provide the requisite net charge density sufficient to shield the positively-charged repulsive forces of at least two reacting nuclei to permit fusion between same, and thereby ignite subsequent fusion reactions to promote and produce a self-sustaining nuclear fusion reaction.

89. An apparatus for promoting a nuclear fusion reaction, said apparatus comprising:
at least one structure having a geometrically-enhanced shape, wherein said structure comprises a net charge density to facilitate electron shielding of positively-charged repulsive forces of at least two reacting nuclei.

90. A method of promoting a nuclear fusion reaction, said method comprising the step of:
a. forming a charged surface, wherein a plurality of electrons proximate to said charged surface are utilized to shield positively-charged repulsive forces of at least two reacting nuclei.

91. A nuclear fusion system, comprising:
at least one surface having a geometrically-enhanced surface;
means for introducing a plurality of electrons proximate to said at least one surface; and
a nuclei fuel source proximal said at least one surface,
wherein said electron introducing means generates a net charge density proximate to said surface, and wherein said electrons serve to shield positively-charged repulsive forces of at least two reacting nuclei of said nuclei fuel source.

92. A system for promoting nuclear fusion reaction, said system comprising:
a reacting surface;
an electrically neutral plane in proximity to said reacting surface;
a reaction fuel disposed between said reacting surface and said electrically neutral plane; and,
an electrical potential difference between said reacting surface and said electrically neutral plane sufficient to promote the nuclear fusion reaction.

93. A system for promoting nuclear fusion reaction, said system comprising:
a reacting surface comprising at least one protrusion extending therefrom, wherein said protrusion comprises at least one apex;
an electrically neutral plane in proximity to said reacting surface;
a reaction fuel disposed between said reacting surface and said electrically neutral plane; and,
an electrical potential difference between said reacting surface and said electrically neutral plane sufficient to promote the nuclear fusion reaction.

94. An apparatus for promoting a nuclear fusion reaction, said apparatus comprising:
a reacting surface in the form of at least one sharply-pointed protrusion.

95. An apparatus for promoting a nuclear fusion reaction, said apparatus comprising:
a reacting surface in the form of at least one protrusion comprising at least one apex.
